(19) United States
(12) Patent Application Publication
(10) Pub. No.: US 2011/0044819 A1
(43) Pub. Date: Feb. 24, 2011

(54) Water Turbine Drive Wheel

(75) Inventor: Pawel Krysztof Licznerski, Bydgoszcz (PL)

Correspondence Address: WILLIAM J. SAPONE;COLEMAN SUDOL SAPONE P.C., 714 COLORADO AVENUE, BRIDGE PORT, CT, 06605, US

(73) Assignee: STERPLANET INC., Middletown, DE (US)

(21) Appl. No.: 12/810,856

(22) PCT Filed: Sep. 16, 2008
(86) PCT No.: PCT/PL08/00067

§ 371 Date: Jun. 28, 2010

(30) Foreign Application Priority Data
Sep. 17, 2007 (PL) 383367

(51) Int. Cl. F03B 7/00

(52) U.S. Cl. 416/223 R

(57) ABSTRACT

The object of the invention is a drive wheel of a water turbine which makes it possible to convert kinetic energy of the water stream into rotational mechanical energy of the turbine. The water turbine drive wheel, according to the invention, is characterized by such features that the angle B between the rotation plane of wheel P and the water stream direction s ranges between 3° to 87° and that the wheel is immersed only partially in the water stream up to the blade height L which is within 0.003 to 0.497 of the outer diameter of the water turbine drive wheel D.

The object of the invention is a drive wheel of a water turbine, in particular a river one, which makes it possible to convert kinetic energy of the water stream into rotational mechanical energy of the turbine.

Famous are both constructions of turbines whose rotation plane is parallel to the water stream direction—working in partial immersion, and such constructions of turbines whose rotation plane is perpendicular to the water stream direction—working in complete immersion.

Famous is the River Turbine claimed as Polish invention on Apr. 21, 2005, Reference No. P 374517, which consists of a number of profiled blades radiating from the hub and which is characterized by such features that the angle between the chord of the immersed blade section and the water stream direction ranges from −13° to +47° and the axis of rotation of the turbine is placed favourably perpendicular to the component of resultant forces generated on the blades, forming acute angle with the water stream direction, whereas the turbine is immersed in the stream below its axis of rotation.

The research in the Polish patent literature does not confirm the existence of any analogical modes of operation or analogical turbine constructions.

The essence of the water turbine drive wheel, according to the invention, is that the angle B between the rotation plane of wheel P and the water stream direction ranges between 3° to 87° and that the wheel is immersed only partially in the water stream up to the blade height L which is within 0.003 to 0.497 of the outer diameter of the water turbine drive wheel D.

The technical advantage of the water turbine drive wheel, according to the invention, is high efficiency of water stream energy transfer, whereas the constructional advantages of the wheel is its simple construction and the possibility of in-building of the inner space of the hub 2 with, for example, a generator.

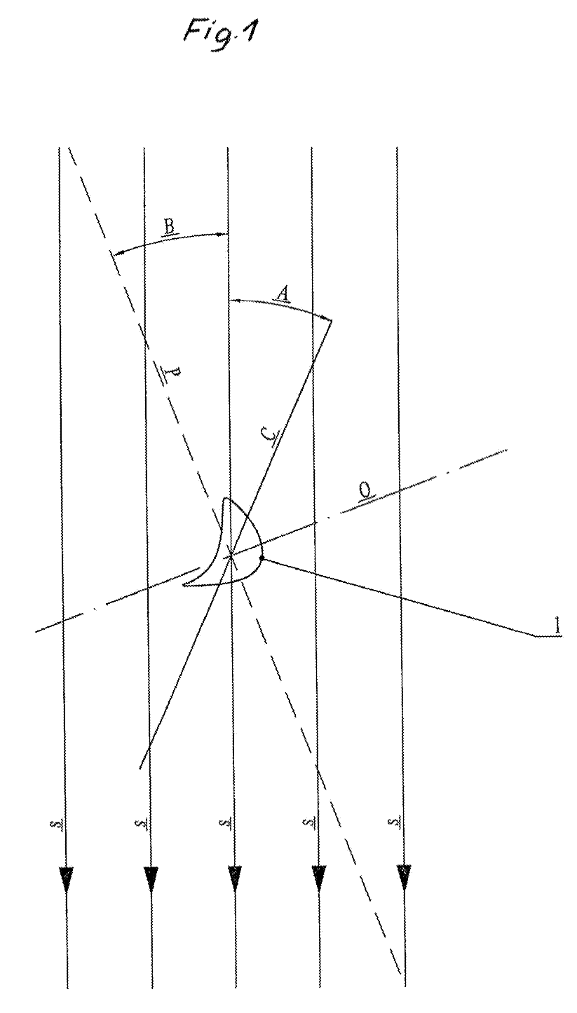

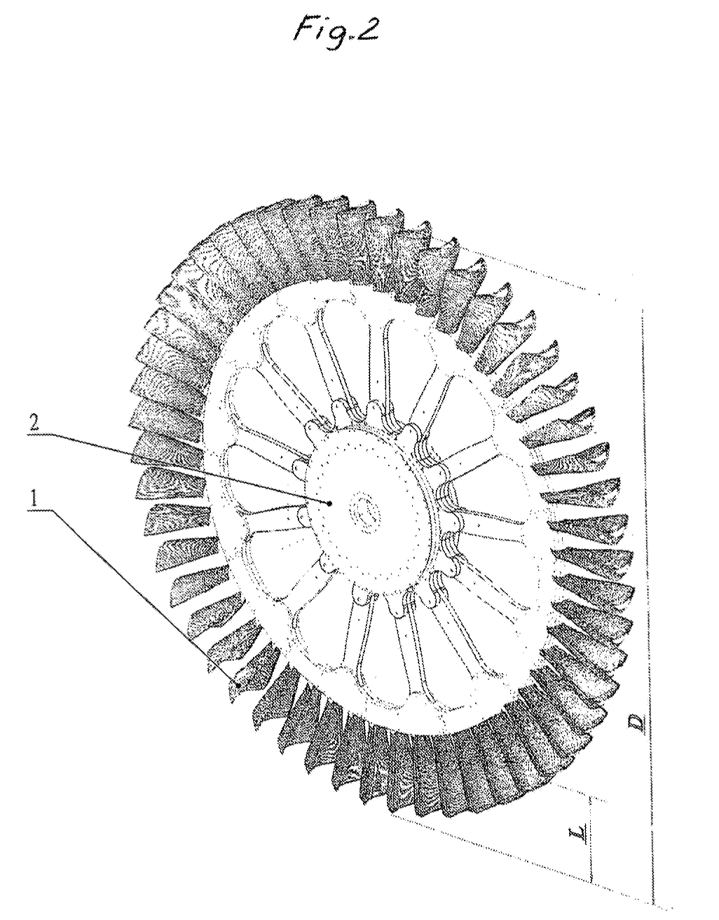

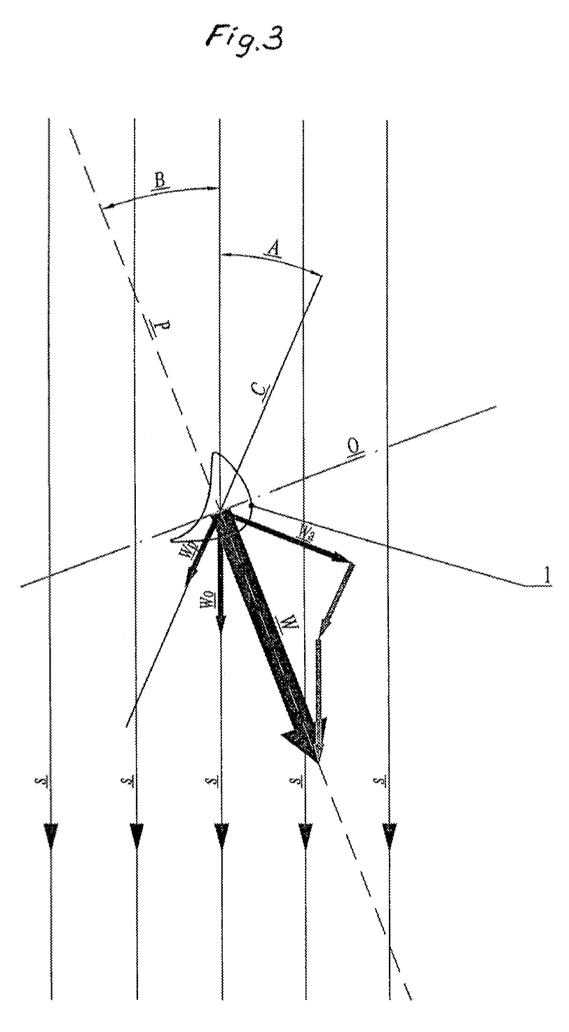

The water turbine drive wheel, according to the invention, has been diagrammatically presented in the form of drawings. FIG. 1 presents the cross-section of one immersed blade with the drive wheel geometry and the water stream marked. FIG. 2 shows a perspective view of the complete drive wheel. FIG. 3 presents the distribution of forces generated on the immersed blade with a graphical presentation of the resultant force.

The water turbine drive wheel, according to the invention, consists of a number of profiled blades 1 with a length L, radiating on the circumference of the drive wheel, whereas the angle B between the rotation plane of the water turbine drive wheel and the water stream direction s ranges between 3° to 87°, and the drive wheel blade height L which ranges from 0.003 to 0.497 of the outer diameter of the water turbine drive wheel D.

The axis of rotation of the water turbine drive wheel O is placed favourably perpendicular to the component W of resultant forces generated on the blades 1, forming angle B with the water stream direction s, whereas the turbine drive wheel is immersed in the water stream s below its axis of rotation O.

The principle of the water wheel operation is that the water stream s, when moving on both sides of the profiled blades 1 due to differential pressure generated on both their profiles surfaces, generates aerodynamic force Wa on the blades 1 making them revolve on the axis O.

The reluctant force W generated on the blades 1 depends on the velocity of water stream s, on the angle A between the chord of the immersed blade section 1 and the water stream direction s, on the angle B between the rotation plane of the water wheel P and the water stream direction s, and on the water environment which may have different viscosity.

The position of the angle B is selected so that the reluctant of all the forces acting on the blade 1, aerodynamic forces Wa, flow resisting force Wo and adhesive force Wo is directed favourably perpendicularly to the axis of rotation O and has the highest possible value.

1. A water turbine drive wheel, consisting of a number of profiled blades radiating from a hub, wherein an angle B between a rotation plane of the wheel P and a water stream moving in a direction s ranges between 3° to 87°, the wheel being only partially immersable in the water stream up to a blade height L, which is within 0.003 to 0.497 of an outer diameter of the water turbine drive wheel D.
